(19) United States
(12) Patent Application Publication
(10) Pub. No.: US 2007/0062120 A1
(43) Pub. Date: Mar. 22, 2007

(54) Multistage movable hinge

(76) Inventor: Liang Chao Liu, Taipei (TW)

Correspondence Address: LIANG CHAO LIU, 235 Chung-Ho, Box 8-24, Taipei, TW

(21) Appl. No.: 11/232,146

(22) Filed: Sep. 22, 2005

(51) Int. Cl. E05D 7/00

(52) U.S. Cl. 49/399

(57) ABSTRACT

A multistage movable hinge for retaining a window frame comprises a connecting sheet; an outer retainer connected to the connecting sheet by a first rotary shaft; and an inner retainer sheet connected to the connecting sheet by a second rotary shaft; a plurality of sealing rubber strips for edges of the outer retainer sheet and inner retainer sheet to window frames of a window. In use, the inner retainer sheet is retained to a window frame by a stud; the outer retainer sheet is retained to another window frame fixed to a wall by a stud; the sealing rubber strips serve to seal the connection between the window frame and the window for sound isolation and buffer the impact between the window frame and the window. Moreover, the connecting sheet is formed by a plurality of sub-sheets.

### FIELD OF THE INVENTION

The present invention relates to hinges, and particularly to a multistage movable hinge, wherein the movable hinge of the present invention has the effect of increasing the strength of the structure so that the window will not fall down, for example, in earthquake. Thereby the opening of the window is increased so that a wide view can be afforded to viewers.

### BACKGROUND OF THE INVENTION

With reference to FIG. 1, the prior art for retaining a window 1 to a window frame 2 is illustrated. In the prior art, a stop 3 connects a window 1 to a window frame 2. When the window 1 is opened, the stop 3 can be used to enhance the fixedness of the window 1. However the prior art has still the following disadvantages. The stop cannot provide an effect support to the window and thus when for a long time, it is possible the window will fall down. Moreover, it is possible that the window drops down due to earthquake.

When the window is opened, a force is counterclockwise applied to the window for driving the inner retainer sheet to rotate so as to separate from the connecting sheet and the outer retainer sheet to rotate so as to separate from the connecting sheet until the window frame resists against the wall. Thereby by the present invention, window can be opened to have a larger angle. Moreover, by the design of the present invention, the structure is flexible and strengthened.

### SUMMARY OF THE INVENTION

Accordingly, the primary object of the present invention is to provide a multistage movable hinge, wherein the movable hinge of the present invention has the effect of increasing the strength of the structure so that the window will not fall down, for example, in earthquake. Thereby the opening of the window is increased and a wide view can be afforded to viewers.

To achieve above objects, the present invention provides a multistage movable hinge for retaining a window frame. The hinge comprises a connecting sheet; an outer retainer connected to the connecting sheet by a first rotary shaft; and an inner retainer sheet connected to the connecting sheet by a second rotary shaft; a plurality of sealing rubber strips for edges of the outer retainer sheet and inner retainer sheet to window frames of a window. In use, the inner retainer sheet is retained to a window frame by a stud; the outer retainer sheet is retained to another window frame fixed to a wall by a stud; the sealing rubber strips serve to seal the connection between the window frame and the window for sound isolation and buffering the impact between the window frame and the hinge. Moreover, the connecting sheet is formed by a plurality of sub-sheets.

The various objects and advantages of the present invention will be more readily understood from the following detailed description when read in conjunction with the appended drawing.

### BRIEF DESCRIPTION OF THE DRAWINGS

FIG. 1 is a schematic perspective view of the prior art hinge structure used in window frame.

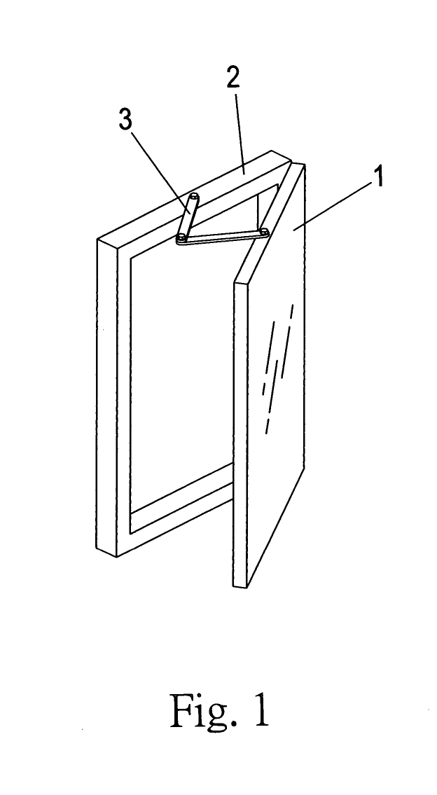

FIG. 2 is an expansion view of the structure of the present invention.

FIG. 3 is a cross sectional view about the operation of the present invention, wherein the window is not opened.

FIG. 4 is a cross sectional view about the operation of the present invention, wherein the window is opened.

FIG. 5 shows the application of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

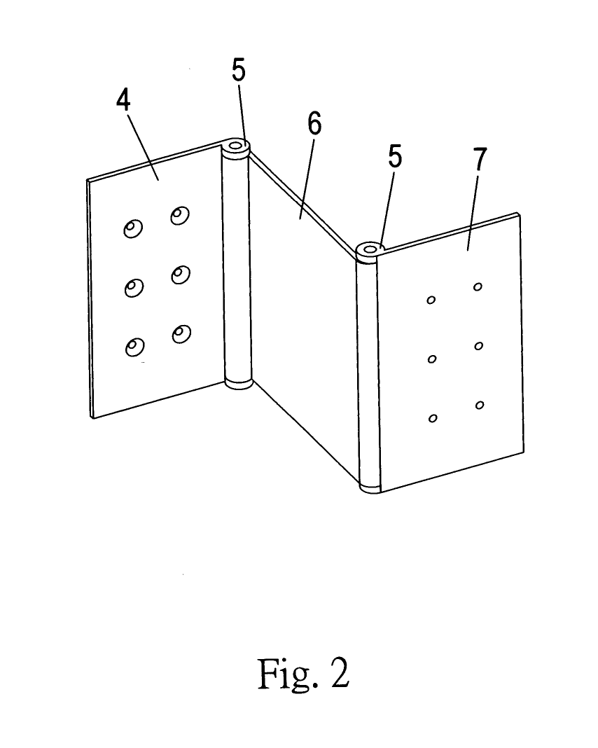

Referring to FIG. 2, the moveable hinge of the present invention is illustrated. The present invention has the following elements.

A body is a symmetrical structure has a connecting sheet 6; an outer retainer 4 connected to the connecting sheet 6 by a first rotary shaft 5; and an inner retainer sheet 7 connected to the connecting sheet 6 by a second rotary shaft 5.

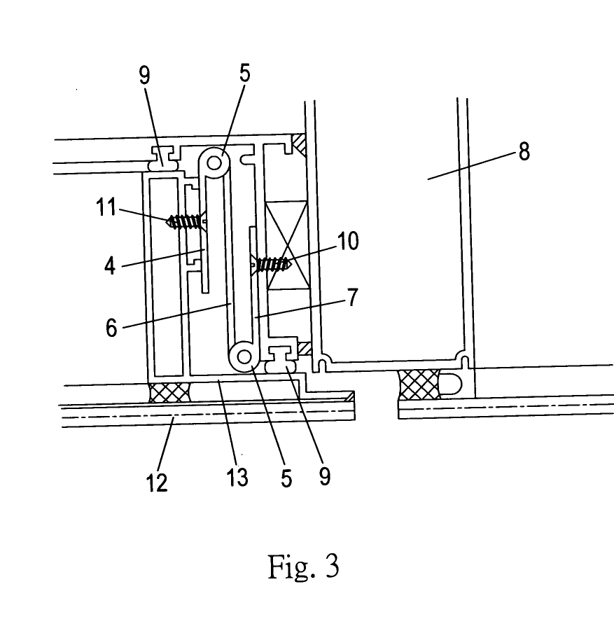

Referring to FIG. 3, the inner retainer sheet 7 is retained to an aluminum extrusion frame 13 of a window frame 8 by a stud 10. The outer retainer sheet 7 is retained to another aluminum extrusion frame 13 fixed to a wall by a stud 11. Sealing rubber strips 9 serve to seal the connection between the window frame 8 and the window 12 for sound isolation and buffer the impact between the window frame 8 and the window 12.

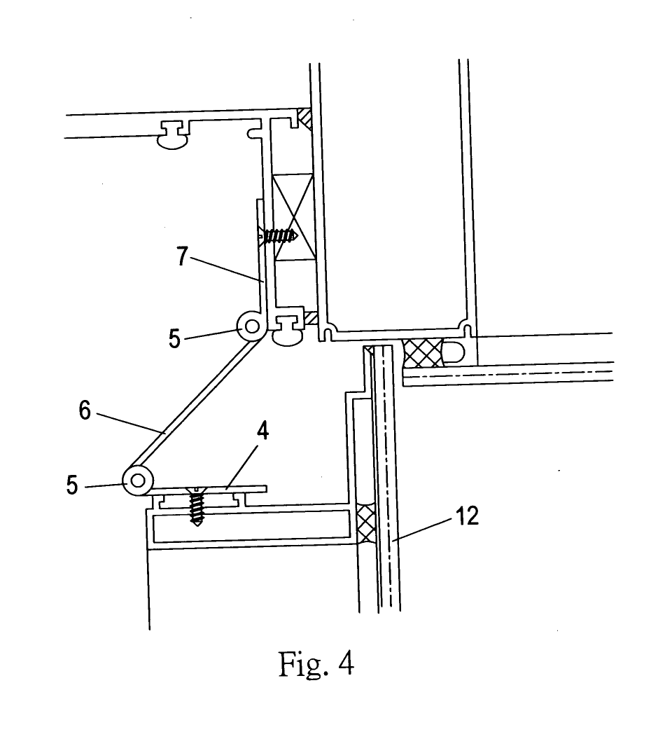

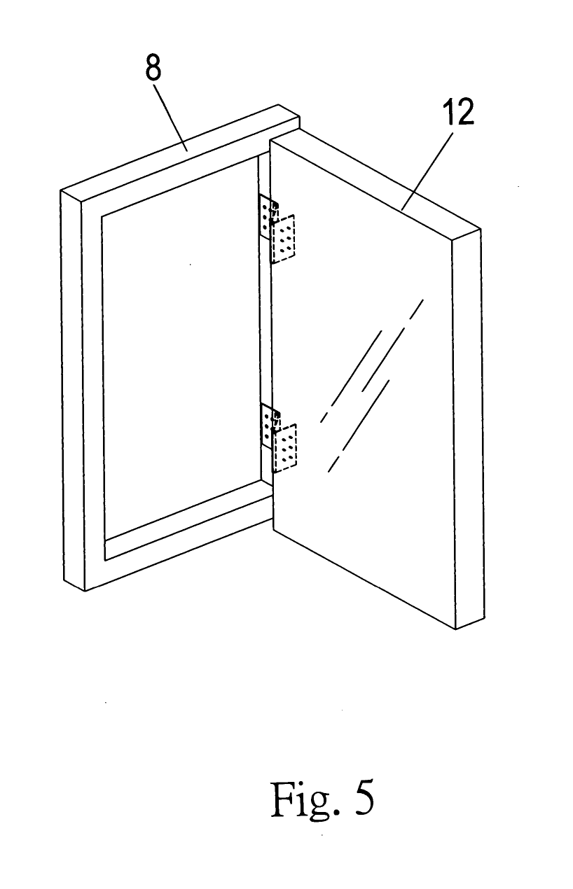

With reference to FIG. 4, when the window 12 is opened, a force is counterclockwise applied to the window 12 for driving the inner retainer sheet 7 to rotate to separate from the connecting sheet 6 and the outer retainer sheet 4 to rotate to separate from the connecting sheet 6 until the window frame 8 resists against the wall, see FIG. 5. Thereby by the present invention, the window 12 can be opened to have a larger angle. Moreover, by the design of the present invention, the structure is flexible and strengthened.

Furthermore, it should be noted that in the present invention, the connecting sheet is formed by a plurality of sub-sheets.

Advantages of the present invention is that the movable hinge of the present invention has the effect of increasing the strength of the structure so that the window will not fall down, for example, in earthquake. Thereby the opening of the window is increased so that a wide view can be afforded to viewers.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multistage movable hinge for retaining a window frame comprising:
a connecting sheet;
an outer retainer connected to the connecting sheet by a first rotary shaft; and
an inner retainer sheet connected to the connecting sheet by a second rotary shaft;
a plurality of sealing rubber strips for edges of the outer retainer sheet and inner retainer sheet to window frames of a window;
wherein in use, the inner retainer sheet is retained to a window frame by a stud; the outer retainer sheet is retained to another window frame fixed to a wall by a stud; the sealing rubber strips serve to seal the connection between the window frame and the hinge for sound isolation and buffer the impact between the window frame and the window.

2. The multistage movable hinge as claimed in claim 1, wherein the connecting sheet is formed by a plurality of sub-sheets.
